(19) United States
(12) Patent Application Publication
(10) Pub. No.: US 2026/0360280 A1
(43) Pub. Date: Nov. 12, 2026

(54) TRAINING MANIKIN AND FOLEY CATHETER THEREFOR

(71) Applicant: North American Rescue, LLC, Greer, SC (US)

(72) Inventors: Corey Crisostomo, Marietta, GA (US); William Adams, Shelbyville, KY (US); Benjamin Scott Clift, Louisville, KY (US); Keary Miller, Eastpoint, FL (US)

(21) Appl. No.: 19/199,582

(22) Filed: May 6, 2025

(51) Int. Cl. G09B 23/30

(52) U.S. Cl. CPC G09B 23/303

(57) ABSTRACT

A catheter training assembly or manikin includes a base block, a mechanical one-way valve, and a fluid bladder bag. A base block defines an internal cavity to receive a catheter therein. The base block further defines an inlet port through a sidewall of the base block in fluid communication with the internal cavity. The mechanical one-way valve is held within the inlet port. The fluid bladder bag is in fluid communication with the internal cavity.

### FIELD OF THE DISCLOSURE

The present subject matter relates generally to medical training devices, and more particularly to assemblies for catheterization training.

### BACKGROUND OF THE DISCLOSURE

Recent developments in armed conflict and mission profiles have provided an impetus for increasing focus on prolonged field care processes and procedures. Fluid management for patients, in particular, has become increasingly important. In order to address this, a transurethral catheter (i.e., Foley catheter) may be used in certain patients. As a result, there is a need to train medical providers prior to or during deployment in the field.

Currently most catheterization training is done on a benchtop using a part task trainer focusing solely on insertion of the catheter. However, such existing trainers often fail to adequately prepare trainees. For instance, existing trainers may provide relatively little feedback for a trainee to assess his or her performance (e.g., beyond confirming if the catheter is fully inserted). Additionally or alternatively, current trainers are generally unable to accurately simulate treating a live patient. Although manikins are widely used to replicate real-life medical scenarios, existing manikins have failed to address the above issues.

Accordingly, it may be useful to provide a manikin or assembly addressing one or more of the above issues. In particular, systems or assemblies that provide a more accurate training experience or live (e.g., tactile) feedback during training would be advantageous.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a catheter training assembly for a manikin is provided. The catheter training assembly may include a base block, a mechanical one-way valve, and a fluid bladder bag. The base block may define an internal cavity to receive a catheter therein. The base block may further define an inlet port through a sidewall of the base block in fluid communication with the internal cavity. The mechanical one-way valve may be held within the inlet port. The fluid bladder bag may be in fluid communication with the internal cavity.

In another exemplary aspect of the present disclosure, a training manikin is provided. The training manikin may include a manikin body, a base block, a mechanical one-way valve, and a fluid bladder bag. The training manikin may include a simulated skeletal frame, a torso section extending about a first portion of the simulated skeletal frame, and a pelvis section extending about a second portion of the skeletal frame below the torso section. The base block may define an internal cavity to receive a catheter therein. The base block may further define an inlet port through a sidewall of the base block in fluid communication with the internal cavity. The mechanical one-way valve may be held within the inlet port. The fluid bladder bag may be in fluid communication with the internal cavity.

In yet another exemplary aspect of the present disclosure, a training manikin is provided. The training manikin may include a manikin body, a base block, a mechanical one-way valve, a reservoir joint, and a fluid bladder bag. The training manikin may include a simulated skeletal frame, a torso section extending about a first portion of the simulated skeletal frame, and a pelvis section extending about a second portion of the skeletal frame below the torso section. The base block may define an internal cavity to receive a catheter therein. The base block may further define an inlet port through a sidewall of the base block in fluid communication with the internal cavity. The inlet port may be directed forward within the manikin body. The mechanical one-way valve may be held within the inlet port. The reservoir joint may be secured to the base block in fluid communication with the internal cavity. The reservoir joint may define a joint inlet directed forward within the manikin body. The fluid bladder bag may be in fluid communication with the internal cavity.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a training manikin, including a catheter assembly, according to exemplary embodiments of the present disclosure;

FIG. 2 provides a perspective view of a catheter assembly according to exemplary embodiments of the present disclosure;

FIG. 3 provides a perspective view of a catheter receiver of a catheter assembly according to exemplary embodiments of the present disclosure;

FIG. 4 provides a side sectional view of the exemplary catheter receiver of FIG. 3;

FIG. 5 provides a schematic sectional view of a catheter assembly according to exemplary embodiments of the present disclosure;

FIG. 6 provides a perspective view of a portion of a catheter assembly and simulated skeletal frame according to exemplary embodiments of the present disclosure; and

FIG. 7 provides an exploded perspective view of a catheter receiver according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Unless specified otherwise, terms such as “inner” and “outer” refer to relative directions with respect to the interior and exterior of a training manikin. For example, “inner” or “inward” refers to the direction towards the interior of the training manikin. Terms such as “left,” “right,” “front,” “back,” “top,” or “bottom” are used with reference to the artificial perspective of the manikin. For example, the manikin arranged upright as if standing would include a “front” that generally corresponds to the chest or abdomen segments of the manikin.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure provides a training tool or assembly (for or as part of a larger manikin) permitting users to practice transurethral catheter (i.e., Foley catheter) insertion and generally training users on catheterization procedures. Aspects of the present disclosure may include a base block into which a catheter may be received (e.g., after passing through a simulated urethral passage). Notably, the base block may be in fluid communication with a fluid bladder bag. During use, fluid may be released from the fluid bladder bag (e.g., through the catheter or urethral passage). For instance, one or more mechanical valves may control the flow of fluid from the fluid bladder or base block. In turn, a trainee may advantageously experience feedback as to the insertion of the cavity. Moreover, the tool or assembly may accurately mimic a real-life bodily response to catheterization (e.g., without requiring one or more electronic pumps or components).

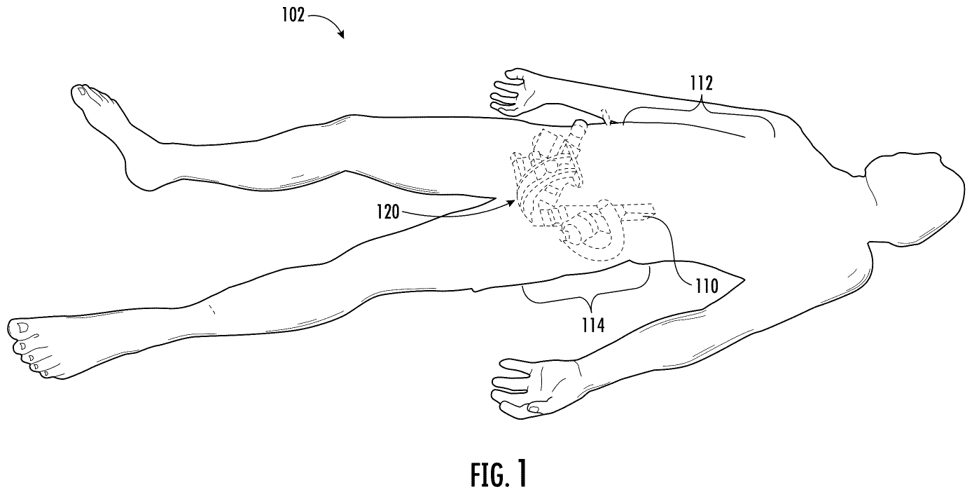

Referring now to the figures, FIG. 1 provides a perspective view of a training manikin 102. As used in the current disclosure, manikin 102 is a life-sized, human-shaped model designed to replicate the anatomy, physiology a real person. The manikin 102 may be a tool for medical training, providing students, healthcare professionals, and emergency responders with a realistic platform to practice a wide range of medical procedures. These procedures may include trauma care, wound treatment, first-aid techniques, surgical techniques, life-saving interventions, and the like.

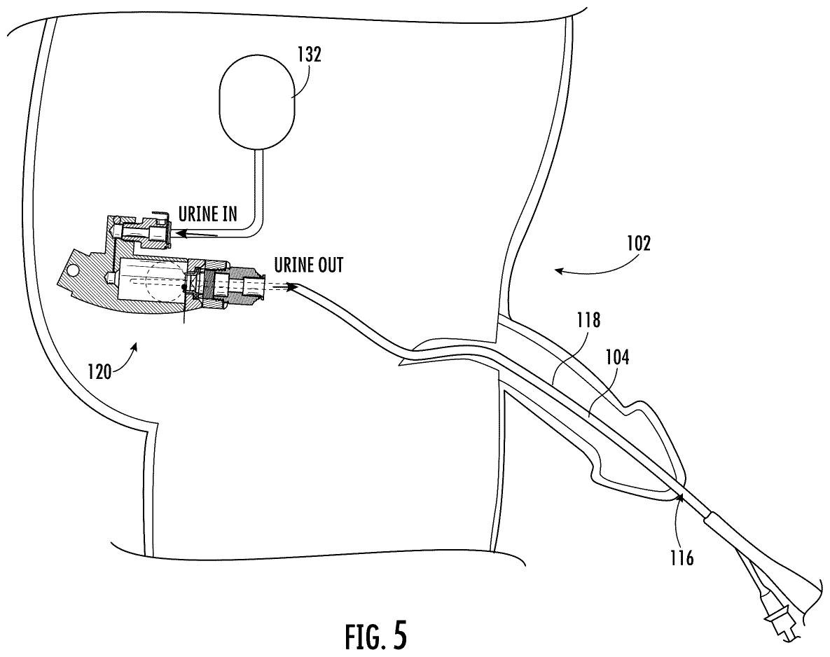

In an embodiment, the manikin 102 may be constructed from silicone or similar substances to closely mimic the texture, flexibility, and resilience of human skin and soft tissues. The use of silicone may allow for a more lifelike tactile experience. In some cases, the manikin 102 may include internal structures, such as simulated bones, muscles, organs, and the like. In particular, the manikin 102 includes a simulated skeletal frame 110 made up of one or more rigid simulated bones, which may generally match or correspond to the overall skeletal structure of a human body (e.g., along the spine, arms, or legs and without requiring a unique simulated bone for each bone of a human body). Moreover, an outer skin or jacket layer (e.g., simulating human skin, muscle, and other tissues) may be provided over or on top of the simulated skeletal frame 110. Although the manikin 102 may exclude or make removable certain simulated body parts (e.g., to more closely mimic disabled individuals or amputees), the manikin 102 may at least include a torso section 112 extending about at least one (e.g., first) portion of the skeletal frame 110 and a pelvis section 114 extending about at least another (e.g., second) portion of the skeletal frame 110 (e.g., below the torso section 112). The pelvis section 114 may further include a simulated genitalia portion having a simulated urethra entry 116. For example, turning briefly to FIG. 5, a simulated penis defining the urethra entry 116 may be provided. However, other embodiments may include a simulated vagina, as would be understood. The urethra entry 116 may be defined by or otherwise connected to a simulated urethra tube 118, which extends within the manikin 102 to (or as part of) a catheter training assembly 120.

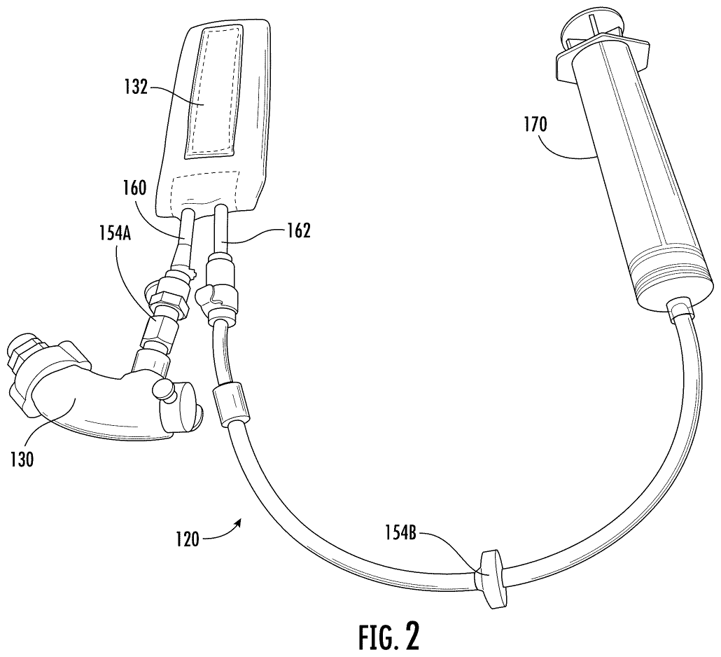

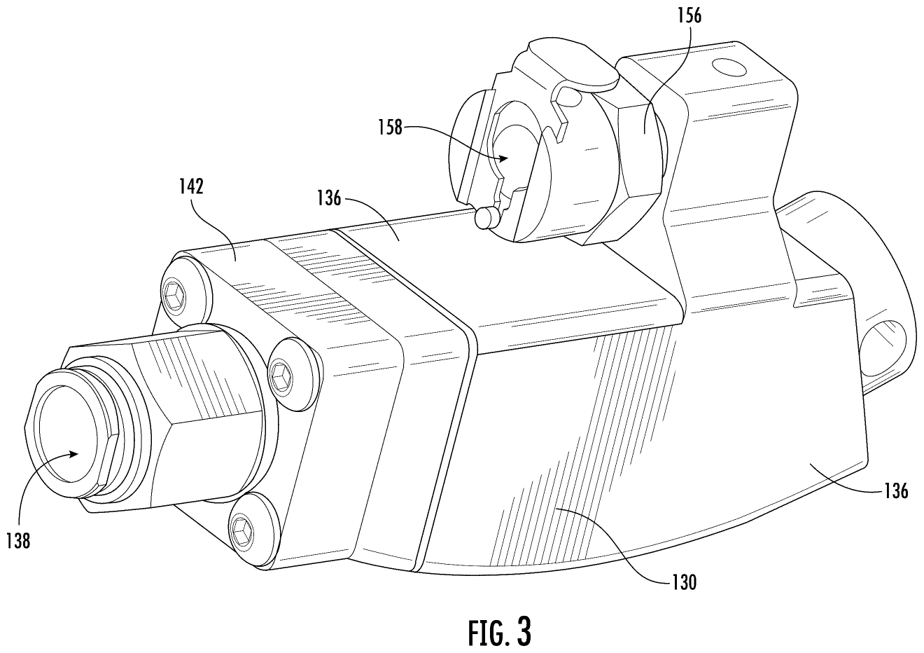

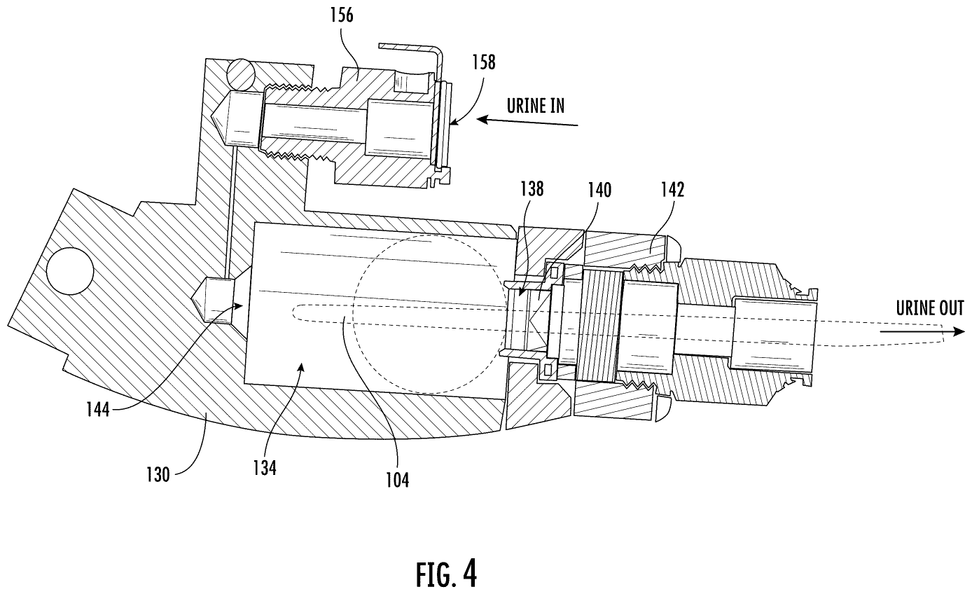

Turning generally to FIGS. 2 through 7, catheter training assembly 120 may be mounted (e.g., all or in part within the manikin 102). As shown, catheter training assembly 120 may include a base block 130 and connected fluid bladder bag 132. As will be described in greater detail below, the base block 130 defines an internal cavity 134 that can communicate with (e.g., receive fluid from) the fluid bladder bag 132. The internal cavity 134 may also be in (e.g., separate) fluid communication with the simulated urethra tube 118 and receive a catheter 104 therein. Along with receiving the catheter 104 therein, the internal cavity 134 may be sized with a sufficient internal diameter to permit inflation of a catheter balloon, as would be understood.

As shown, the base block 130 may include or be provided as a solid body within which the internal cavity 134 is defined. Thus, the base block 130 may include one or more sidewalls 136 bounding or surrounding the internal cavity 134. Optionally, one or more of the sidewalls 136 may be separable or formed as a discrete member from the rest of the base block 130 that, when joined together, at least partially encloses or defines the internal cavity 134. Additionally or alternatively, at least one of the sidewalls 136 may define an inlet port 138 therethrough. Specifically, the inlet port 138 may include a diameter (e.g., smaller than the internal cavity 134 that) extends fully through the corresponding sidewall in fluid communication with the internal cavity 134. The inlet port 138 may serve as a connection point for the base block 130 and urethra tube 118. Thus, the urethra tube 118 may connect to the base block 130 through the inlet port 138. When assembled within the manikin 102, the inlet port 138 may be directed or oriented forward, and thus in the direction of a front of the manikin 102.

In some embodiments, a mechanical (e.g., passive) one-way valve 140 is provided in fluid communication between the internal cavity 134 and the urethra tube 118. For instance, the mechanical one-way valve 140 may be held within the inlet port 138. The mechanical one-way valve 140 may be oriented upstream from the internal cavity 134. Thus, the mechanical one-way valve 140 may be configured to prevent or otherwise restrict fluid from the internal cavity 134 to the urethra tube 118. In certain embodiments, the mechanical one-way valve 140 includes or is provided as a pinch valve, having an elastic tubing body selectively pinched close to control unidirectional flow. During use, the forced insertion of the catheter may be able to open the mechanical one-way valve 140, thereby permitting the catheter 104 to pass to the internal cavity 134.

In optional embodiments, a compression block 142 is joined or otherwise connected to the base block 130 at the inlet port 138. For instance, the compression block 142 may define its own block aperture aligned coaxially with the inlet port 138. When assembled, the compression block 142 may provide an axial clamping force against the mechanical one-way valve 140, notably reducing torque applied to the mechanical one-way valve 140 (e.g., during insertion of the catheter 104). Additionally or alternatively, the compression block 142 may prevent leakage (e.g., around or from a counteracting force at the catheter balloon).

Separately from or in addition to the inlet port 138, the base block 130 may define a reservoir port 144. The reservoir port 144 may, for instance, define a separate passage or fluid-flow point for fluid to the internal cavity 134. Generally, the internal cavity 134 extends (e.g., along a forward-rearward path) from a first end (e.g., at the entry point) to a second or terminal end. In some embodiments, the reservoir port 144 is disposed at the second end of the internal cavity 134. For instance, the reservoir port 144 may be defined at the second (e.g., rearward) end while the inlet port 138 is defined at the first (e.g., forward) end. When assembled, the reservoir port 144 may be in fluid communication between the fluid bladder bag 132 and the internal cavity 134 (e.g., to direct a fluid thereto). Specifically, the reservoir port 144 may be disposed upstream from the internal cavity 134 and downstream from the fluid bladder bag 132. Thus, fluid flowing from the fluid bladder bag 132 to the internal cavity 134 may be required to pass through the reservoir port 144.

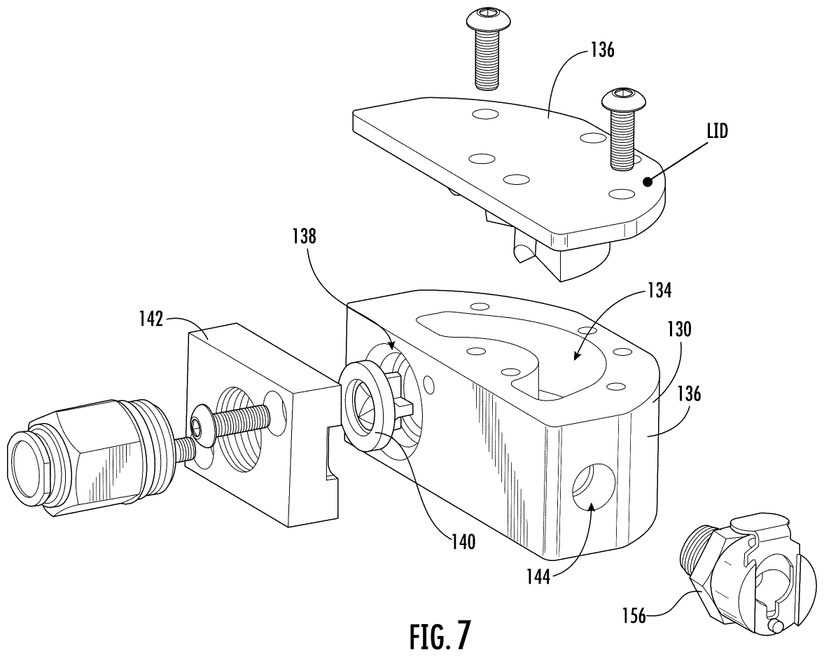

It is noted that although embodiments of FIGS. 2 through 6 illustrate the reservoir port 144 at a rearward end of a linear internal cavity 134, other suitable arrangements may be provided. For instance, as shown in FIG. 7, alternative embodiments of base block 130 may define an arcuate internal cavity 134 extending along a set curve (e.g., arc) path from the first end to the second end (e.g., to accommodate an additional length of the catheter 104).

Returning generally to FIGS. 2 through 7, in some embodiments, a reservoir joint 156 is secured to the base block 130 in fluid communication with the internal cavity 134. In particular, the reservoir joint 156 may attach to the base block 130 in fluid communication with and upstream from the reservoir port 144. Thus, the reservoir joint 156 may be in fluid communication between the fluid bladder bag 132 and the reservoir port 144. In some such embodiments, the reservoir joint 156 provides or forms a fluid connection between the base block 130 and the fluid bladder bag 132 or an output conduit 160 extending from the same. Specifically, the reservoir joint 156 may define a joint inlet 158 at which the fluid bladder bag 132 (or output conduit 160) connects to the base block 130. When assembled within the manikin 102, the joint inlet 158 may be directed or oriented forward, and thus in the direction of a front of the manikin 102.

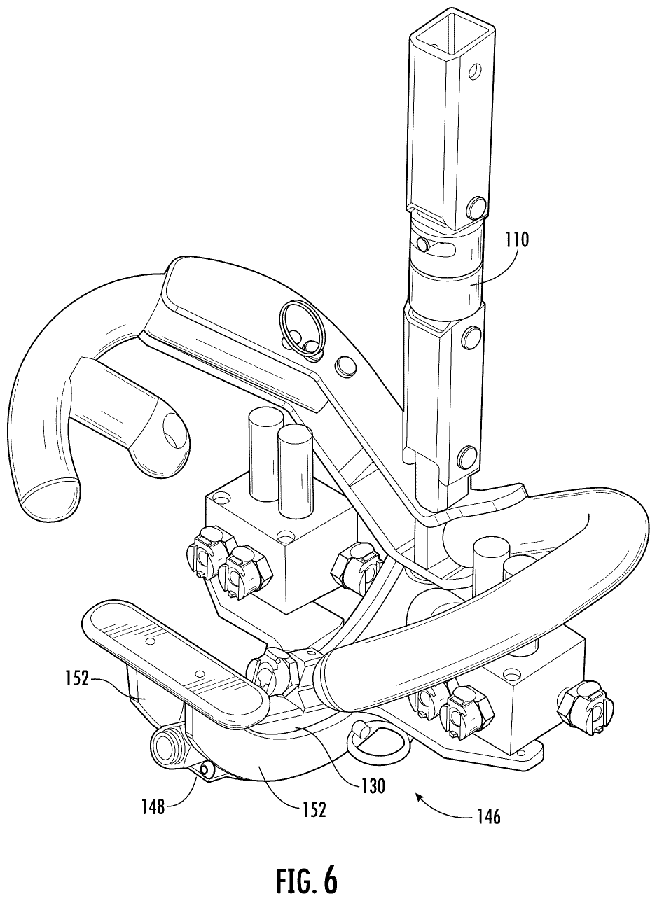

Turning especially to FIG. 6, at least a portion of the catheter training assembly 120 may be joined to or otherwise mounted on skeletal frame 110. For instance, base block 130 may be supported on a portion of skeletal frame 110. In the illustrated embodiments, base block 130 is disposed on a simulated pelvic girdle structure 146 (e.g., of the pelvic section). As shown, a central lower plate 148 may extend below base block 130. When assembled, base block 130 may rest on the central lower plate 148. In additional or alternative embodiments, a pair of side plates 152 laterally bound base block 130. Thus, the side plates 152 may cradle or hold base block 130 therebetween. Optionally, a mounting pin may extend through one or more apertures (e.g., defined in one or more of the pair of side plates 152) as well as a corresponding pin hole defined by the base block 130 and laterally aligned with the one or more apertures. Notably, base block 130 may thus be secured within the manikin 102 while relying on relatively few mounting features.

Returning especially to FIGS. 2 and 5, as noted above, a fluid bladder bag 132 in fluid communication with the internal cavity 134. Fluid bladder bag 132 may generally be provided as a suitable reservoir container within which a liquid fluid may be received. In certain embodiments, fluid bladder bag 132 includes or is provided as an elastic container or bag. For instance, fluid bladder bag 132 may be or include a non-rigid bag formed from a resilient (e.g., natural or synthetic) polymer, such as rubber, latex, or a thermoplastic elastomer. Notably, the fluid bladder bag 132 may be pressurized (e.g., by gravity and a predetermined volume of fluid therein) such that pressure of a released fluid from the fluid bladder bag 132 decreases as the fluid bladder bag 132 is emptied (e.g., of its corresponding liquid fluid) and, thereby, accurately mimics the variations in bladder pressure that occur in the human body.

In some embodiments, a (e.g., first) bladder valve or restrictor (e.g., flow-control orifice) 154A is provided in fluid communication between the base block 130 (e.g., at the internal cavity 134) and the fluid bladder bag 132. In some embodiments, the bladder restrictor 154A includes or is provided as a restricted throat or passage segment that has a reduced diameter or cross-sectional area (e.g., less than or equal to than 80% of the upstream or downstream segment of output conduit 160). Optionally, the diameter of restrictor 154A may be less than 0.1 inches (e.g., about 0.05 inches or about 0.03 inches). In turn, the bladder restrictor 154A may reduce an initial flow of fluid from the bladder bag 132 into the base block 130 and increases the amount of time it takes to fully empty the bladder bag 132 (e.g., when compared to a system in which restrictor 154A is absent). Notably, restrictor 154A may further reduce the bypass flow past the catheter 104 as it initially penetrates valve one-way valve 140. Additionally or alternatively, restrictor 154A may prevent the bladder bag 132 from emptying before a trainee is able to properly position the catheter 104 in the base block 130 and inflate the catheter balloon.

Separate from or in addition to the output conduit 160, an input conduit 162 may be provided upstream from the fluid bladder bag 132 (e.g., at a fluid inlet thereof). A fluid pump 170 (e.g., syringe) may fluidly connect (e.g., selectively) with the fluid bladder bag 132, such a through the input conduit 162. In turn, a liquid fluid may be provided or pressurized within the fluid bladder bag 132.

In some embodiments, a (e.g., second) bladder valve 154B is provided in fluid communication between the fluid bladder bag 132 and the fluid pump 170. The bladder valve 154B may include or be provided as a suitable valve, such as a one-way valve (e.g., wing check valve, lift check valves ball check valve, tilting disc check valve, or pinch valve) oriented upstream from the fluid bladder bag 132. Thus, the bladder valve 154B may be configured to prevent or otherwise restrict fluid from the fluid bladder bag 132 to flow toward the fluid pump 170. During use, the force of the pressurized fluid may be able to open the bladder valve 154B, thereby permitting the fluid to pass to the fluid bladder bag 132.

During use, a user (e.g., trainee) may be able to insert the catheter into the catheter training assembly (e.g., via the urethra entry). The mechanical one-way valve may notably provide an increased pressure and tactile feedback as the catheter moves into the internal cavity. Within the internal cavity, an amount of liquid fluid may be supplied (e.g., by the fluid bladder bag). If the catheter is properly inserted, the liquid fluid may flow through the catheter. By contrast, if the catheter is not properly inserted, liquid fluid may fail to flow or flow around the catheter (e.g., to the urethra entry).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A catheter training assembly for a manikin, the catheter training assembly comprising:
a base block defining an internal cavity to receive a catheter therein, the base block further defining an inlet port through a sidewall of the base block in fluid communication with the internal cavity;
a mechanical one-way valve held within the inlet port; and
a fluid bladder bag in fluid communication with the internal cavity.

2. The catheter training assembly of claim 1, wherein the mechanical one-way valve comprises a pinch valve.

3. The catheter training assembly of claim 1, wherein the mechanical one-way valve is disposed upstream from the internal cavity to restrict fluid from the internal cavity.

4. The catheter training assembly of claim 1, wherein the internal cavity extends from the inlet port to a terminal end.

5. The catheter training assembly of claim 4, wherein the base block further defines a reservoir port to the internal cavity at the terminal end, the reservoir port being in fluid communication between the fluid bladder bag and the internal cavity to direct a fluid thereto.

6. The catheter training assembly of claim 1, further comprising a bladder valve in fluid communication between the internal cavity the fluid bladder bag.

7. The catheter training assembly of claim 6, wherein the bladder valve comprises a one-way valve disposed upstream from the internal cavity to restrict fluid from the internal cavity to the fluid bladder bag.

8. A training manikin comprising:
a manikin body comprising a simulated skeletal frame, a torso section extending about a first portion of the simulated skeletal frame, and a pelvis section extending about a second portion of the simulated skeletal frame below the torso section;
a base block mounted to the simulated skeletal frame within the pelvis section, the base block defining an internal cavity to receive a catheter therein, the base block further defining an inlet port through a sidewall of the base block in fluid communication with the internal cavity;
a mechanical one-way valve held within the inlet port; and
a fluid bladder bag mounted within the manikin body in fluid communication with the internal cavity.

9. The training manikin of claim 8, wherein the mechanical one-way valve comprises a pinch valve.

10. The training manikin of claim 8, wherein the mechanical one-way valve is disposed upstream from the internal cavity to restrict fluid from the internal cavity.

11. The training manikin of claim 8, wherein the internal cavity extends from the inlet port to a terminal end.

12. The training manikin of claim 11, wherein the base block further defines a reservoir port to the internal cavity at the terminal end, the reservoir port being in fluid communication between the fluid bladder bag and the internal cavity to direct a fluid thereto.

13. The training manikin of claim 8, further comprising a bladder valve in fluid communication between the internal cavity the fluid bladder bag.

14. The training manikin of claim 13, wherein the bladder valve comprises a one-way valve disposed upstream from the internal cavity to restrict fluid from the internal cavity to the fluid bladder bag.

15. A training manikin comprising:
a manikin body comprising a simulated skeletal frame, a torso section extending about a first portion of the simulated skeletal frame, and a pelvis section extending about a second portion of the simulated skeletal frame below the torso section;
a base block mounted to the simulated skeletal frame within the pelvis section, the base block defining an internal cavity to receive a catheter therein, the base block further defining an inlet port through a sidewall of the base block in fluid communication with the internal cavity, the inlet port being directed forward within the manikin body;
a mechanical one-way valve held within the inlet port upstream from the internal cavity to restrict fluid from the internal cavity;
a reservoir joint secured to the base block in fluid communication with the internal cavity, the reservoir joint defining a joint inlet directed forward within the manikin body; and
a fluid bladder bag mounted within the manikin body in fluid communication with the internal cavity.

16. The training manikin of claim 15, wherein the mechanical one-way valve comprises a pinch valve.

17. The training manikin of claim 15, wherein the internal cavity extends from the inlet port to a terminal end.

18. The training manikin of claim 17, wherein the base block further defines a reservoir port to the internal cavity at the terminal end, the reservoir port being in fluid communication between the fluid bladder bag and the internal cavity to direct a fluid thereto.

19. The training manikin of claim 15, further comprising a bladder valve in fluid communication between the internal cavity the fluid bladder bag.

20. The training manikin of claim 19, wherein the bladder valve comprises a one-way valve disposed upstream from the internal cavity to restrict fluid from the internal cavity to the fluid bladder bag.
